(19) United States
(12) Patent Application Publication
(10) Pub. No.: US 2017/0308997 A1
(43) Pub. Date: Oct. 26, 2017

(54) METHOD AND SYSTEM FOR PROCESSING AN IMAGE FRAME SHOWING A BIODEGRADABLE MEDICAL DEVICE IN A PART OF A HUMAN BODY

(71) Applicant: Abbott Laboratories Services Corp., Taiwan Branch, Taipei (TW)

(72) Inventor: Daniel G. Silver, Taipei (TW)

(73) Assignee: Abbott Laboratories Services Corp., Taiwan Branch, Taipei (TW)

(21) Appl. No.: 15/134,283

(22) Filed: Apr. 20, 2016

(51) Int. Cl. G06T 5/00; G06T 7/60

(52) U.S. Cl. CPC G06T 5/003; G06T 7/60; G06T 2207/30048; G06T 2207/30021; G06T 2207/20101; G06T 2207/10116; G06T 2207/30204; G06T 2207/20192

(57) ABSTRACT

The invention provides solutions to process an image frame showing a biodegradable medical device in a part of a human body by the steps of presenting, with the processor, an interactive interface for human-computer interaction, receiving a designation of a specific model type of the biodegradable medical device from a user via the interactive interface, and identifying, with the processor, a plurality of markers of the biodegradable medical device based on specifications of the model type of the biodegradable medical device.

### FIELD OF THE INVENTION

The present invention generally relates to a method and system for processing an image frame showing a biodegradable medical device in a part of a human body.

### BACKGROUND OF THE INVENTION

Biodegradable medical devices, such as coronary stents, vascular scaffolds, surgical suture, bone screw, and bone plate, made from biodegradable materials, such as biodegradable plastic, polylactic acid (PLA), polylactic acid polymer, polyhydroxy-alkanoates (PHA), collagen, etc., are commonly used to reside in human bodies through medical surgeries for their excellent absorbability. However, due to their low radiodensity, images of the biodegradable medical devices are usually blurred under X-ray, and this may hinder the process of the surgery or effect correctness of follow-up observation.

For example, when undergoing a coronary angioplasty, cardiac angiography, in which the light source is X-ray, is utilized for discrimination to the position of a coronary stent inside a human body. This is crucial because the stent has to be placed right under a plaque in a vessel, and then expanded with the support of a balloon coaxially mounted therein. In addition, after the surgery for a while, usually 3 to 6 months, depending on doctor's advise in different cases, a follow-up observation for restenosis may be proceeded.

Therefore, it is a need for a method for enhancing the image of a biodegradable medical device under X-ray so as to facilitate medical treatment and observation.

### SUMMARY OF THE INVENTION

An object of the present invention is to provide a method and a system for processing an image frame showing a biodegradable medical device in a part of a human body. According to an embodiment of the invention, the biodegradable medical devices may be used in a medical surgery for treating or healing a patient in an operation room, an examination room, a ward or the like in one of a clinic, a hospital, a health center, medical station and so forth and may exemplarily comprise biodegradable medical devices made from biodegradable materials, such as coronary stents, vascular scaffolds, surgical suture, bone screw, bone plate, etc.

According to an embodiment of the invention, a plurality of markers may be mounted on the biodegradable medical device, embedded in the biodegradable medical device, or attached to the biodegradable medical device, and preferably, the markers may be placed in a vicinity of an end of the biodegradable medical device. The shape, number, material of the markers may be not limited, but preferably, the markers may be made from material with high radiodensity. In an implementation, the markers may be two pairs of metal beads or two metal beads, one of which is placed in a vicinity of an end of the biodegradable medical device and the other of which is in a vicinity of another end of the biodegradable medical device. In another implementation, the markers may be two metal pieces with distinctive shape and each of the pieces is placed in a vicinity of an end of the biodegradable medical device. The shape, number or arrangement of the markers may correspond to the model type of the biodegradable medical device.

In an embodiment of the invention, the processor executing the method of the present invention may be installed in a stand-alone machine or a member machine of either a picture archiving and communication system (PACS), a radiological information system (RIS) or a hospital information system (HIS), such as a medical machine, terminator, counter, workstation, tablet, computer, central server, database, preferably but not limited to a stand-alone X-ray angiography system or a X-ray angiography system in PACS.

Generally speaking, at least one image frame, preferably a plurality of image frames, showing a biodegradable medical device in a part of a human body may be generated for the medical surgery or a follow-up observation with the help of the PACS in a clinic, a hospital, a health center, medical station, etc. Through technologies such as computerized radiography (CR), digitalized radiography (DR), video capture, etc., preferably, the image frame may be homologous with variation in X-ray absorption distributed on an image carrier, which may be but not limited to a phosphor imaging plate with wider exposure latitude, cesium iodine (CsI)/charge-coupled device (CCD) flat panel, CsI/amorphous silicon (A-Si) flat panel, amorphous selenium (A-Se) fluid with pixel panel constructed by capacitors and thin-film transistor (TFT).

In one aspect of the invention, an embodiment of the invention is provided that a method for processing an image frame showing a biodegradable medical device in a part of a human body comprises executing on a processor the steps of presenting, with the processor, an interactive interface for human-computer interaction, receiving a designation of a specific model type of the biodegradable medical device from a user via the interactive interface, and identifying, with the processor, a plurality of markers of the biodegradable medical device based on specifications of the model type of the biodegradable medical device.

For facilitating application of the invention, in an embodiment of the invention, the interactive interface may be provided with the processor for further receiving more confirmations or directions, for example, receiving a selection of the image frame to be presented from the user, and receiving an acceptance of the identification of the markers from the user, receiving a designation of a specific model type of a biodegradable medical device from the user, receiving an activation of generating enhanced representations for the markers in the subsequent image frame, and/or receiving an activation of drawing a simulated reconstruction of the biodegradable medical device in the subsequent image frame.

In an embodiment of the invention, it is optional to further analyze the markers for matching a specific model type of the biodegradable medical device, and then the result may be presented with the processor, preferably on the interactive interface. These steps may be implemented for various scenarios. For example, in one scenario, the analysis may be carried out with the processor for estimating an apparent feature comprising at least one of size, shape of the markers and relative distance between the markers, and then the result, the estimated apparent feature, may be presented on the interactive interface. In another scenario, the analysis may be carried out with the processor for estimating an apparent feature comprising at least one of size, shape of the markers and relative distance between the markers, matching the apparent feature in a data structure in which specifications of at least one model type of the biodegradable medical device are listed, and then the result, a specific model type number of the biodegradable medical device matching the apparent feature on the interactive interface, may be presented and the interactive interface may be utilized for receiving a confirmation representing that the markers match the specific model type of the biodegradable medical device from the user.

For facilitating identification to the position, model type, size, shape, etc. of the biodegradable medical device in the image frame(s), in an embodiment of the invention, enhanced representations for the markers may be generated by the processor in the current image frame, preferably upon receiving acknowledgement of match. A simulated reconstruction of the biodegradable medical device may be drawn by the processor in the current image frame as well.

Given that more image frames may be utilized for identify the biodegradable medical device, more step(s) such as extracting edges of a graphical feature, which is beyond the markers, such as physical landmark, mechanical landmark, etc., in the first image frame, determining coordinates of the graphical feature relative to the markers, determining respective change in coordinates of the markers in a subsequent image frame, generating the enhanced representations for the markers in the subsequent image frame according to the determined respective change in coordinates of the markers, and/or drawing the simulated reconstruction of the biodegradable medical device adjacent to or between the markers in the subsequent image frame according to the determined respective change in coordinates of the markers may be executed by the processor.

In an embodiment of the invention, the step of identifying the markers of the biodegradable medical device in a vicinity of the position in the image frame may be performed with but not limited to detecting a shape of the markers in the vicinity of the position with technology such as densitometry, grayscale differentiation or the like, and moreover, the shape of other feature in the image frame, such as the graphical feature, an object may be identified in a similar way. The step of identifying the markers of the biodegradable medical device may be performed based on information provided in the specifications of the model type of the biodegradable medical device. For instance, the information of the shape of the markers provided in the specifications of the biodegradable medical device may be used to distinguish the markers from other object showing in the image frame, so as to facilitate identifying the markers.

In another embodiment of the invention, the simulated reconstruction of the biodegradable medical device may be generated based on the identified markers, together with the geometry of the biodegradable medical device available in the specifications of the model type of the biodegradable medical device.

In another aspect of the invention, an embodiment of the invention is provided that a system for processing an image frame showing a biodegradable medical device in a part of a human body, comprising at least one display device, a human-computer interaction device and a processor. The display device displays an interactive interface and the image frame, the human-computer interaction device receives a confirmation or direction from a user, and the processor is configured to execute a method as mentioned above.

The display device may be chosen from but not limited to a projector, a monitor, a display panel, etc., and the human-computer interaction device of may be chosen from but not limited to a mouse, a keyboard, a touch sensor integrated with the display panel, a stylus to touch the touch sensor, etc.

Therefore, through the steps/elements as mentioned above, the location of the biodegradable medical device may be accurately estimated in at least one image frame, and if it is desirable, the model type of the biodegradable medical device inside the human body may be accurately verified or matched, and/or the image frame may be shown with a simulated reconstruction of the biodegradable medical device for facilitating observation.

### BRIEF DESCRIPTION OF THE DRAWINGS

Various objects and advantages of the present invention will be more readily understood from the following detailed description when read in conjunction with the appended drawing, in which:

FIG. 1 shows a structure of an example embodiment of a biodegradable medical device;

FIG. 2 shows another structure of the example embodiment of the biodegradable medical device shown in FIG. 1;

FIG. 3 shows an example embodiment of a system for processing an image frame showing a biodegradable medical device in a part of a human body according to an embodiment of the invention;

FIG. 4 shows an example embodiment of an interactive interface according to an embodiment of the invention;

FIG. 5A and FIG. 5B illustrate an example embodiment of a flow chart of a method for processing an image frame showing a biodegradable medical device in a part of a human body according to an embodiment of the invention;

FIGS. 6A-6F illustrate an example embodiment of the processed image frame shown in the interactive interface in the steps of the method as illustrated in FIG. 5A and FIG. 5B.

### DESCRIPTION OF EMBODIMENTS OF THE INVENTION

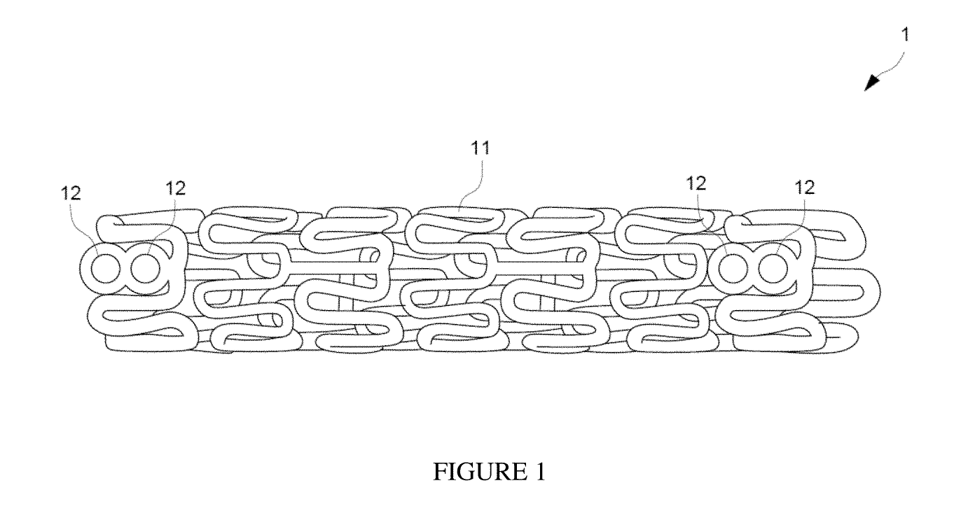

Please refer to FIG. 1, which shows a structure of an example embodiment of a biodegradable medical device having a main frame 11 and a plurality of markers 12. In the present embodiment, the biodegradable medical device 1 may be an exemplary coronary stent 1, the main frame 11 of the coronary stent 1 may be an expandable tube, made from polylactic acid polymer, constructed by wiggles connected together, and the markers 12 may be a pair of beads, made from metal, such as platinum, inlaid on the main frame 11 in a vicinity of an end of the main frame 11. The coronary stent 1 may be a drug-eluting stent or a bare coronary stent. Please note that the numbers and shape of the markers 12 may be variable, such as only a bead at one end and two beads at the other, one line at each end, etc., and the relative distance, shape, number, etc. of the markers 12 may be related to the model type of the biodegradable medical device 1. Further, the material of the markers 12 may be chosen from various materials with high radiodensity, compared with the material to make the main frame 11.

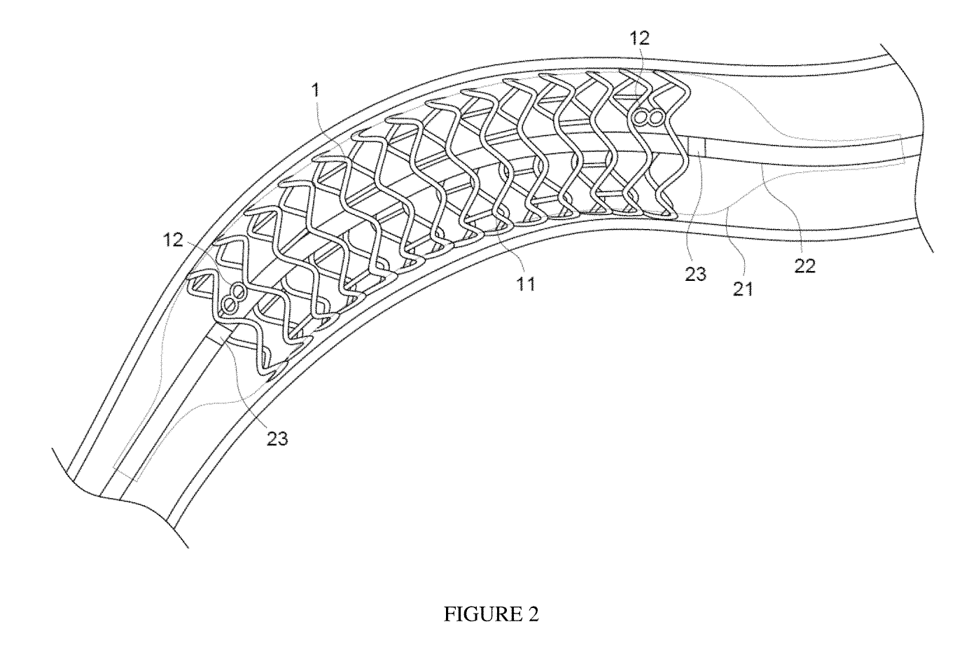

Please refer to FIG. 2, which shows another structure of the example embodiment of the biodegradable medical device 1 shown in FIG. 1. A balloon 21 is fixed attached to a guidewire 22 which is provided with two marker bands 23, each of which is about an end of the coronary stent 1. During a coronary angioplasty, the balloon 21 along with the coronary stent 1 are moved and placed to right under a plaque in a vessel, and then the balloon 21 inside the coronary stent 1 is inflated to expanding the coronary stent 1 to press the plaque into the vessel wall, support the vessel and keep the blood flowed therein. Then, the biodegradable medical device 1 will be gradually degraded in the human body.

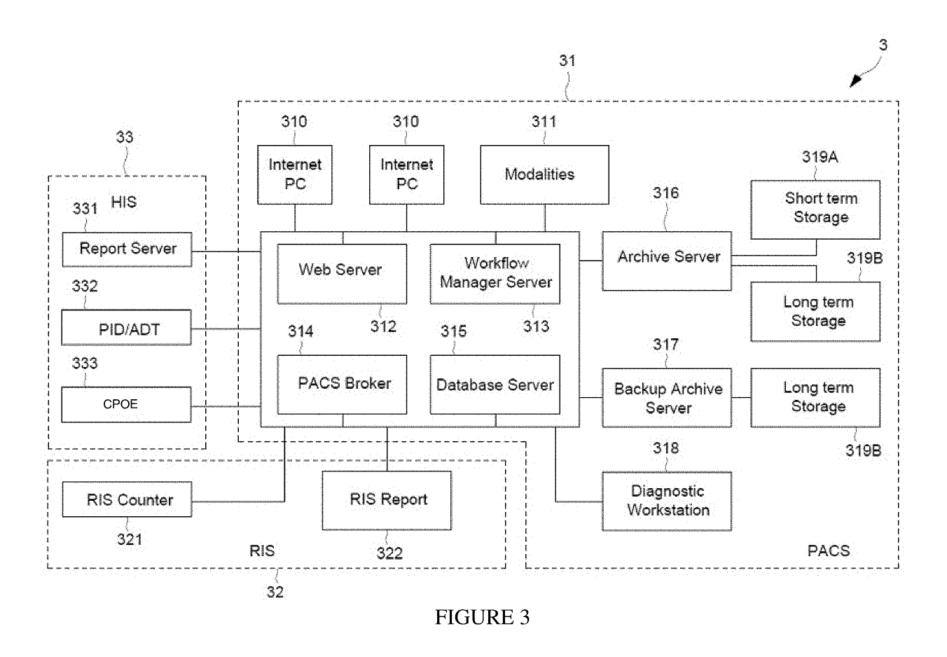

Please refer to FIG. 3, which shows an example embodiment of a system 3 for processing at least one image frame showing a biodegradable medical device 1 in a part of a human body according to an embodiment of the invention. In the present example embodiment, the system 3 may be constructed by but not limited to a picture archiving and communication system (PACS) 31, a radiological information system (RIS) 32 or a hospital information system (HIS) 33. Communication links capable to transmit and receive data, instructions, commands and/or requests between devices coupled thereon are provided to each of the PACS 31, RIS 32 and HIS 33. However, the communication links may be implemented into species each of which may be operated through a medium to link a network such as internet, intranet, and the like, an electrical device, an electrical circuitry, etc., to convey at least one message which carries at least one of data, instructions, commands and requests. For example, the medium may be chosen from but not limited to a telephone line, CAT-5 cable, coaxial copper cable, wireless radio, terrestrial radio, satellite radio, etc., and the communication links may be chosen from but not limited to an internet link, intranet link, RFID link, and hardware links such as RS232 serial link, RS485 serial link, GPIB (General Purpose Interface Bus) link, Ethernet link, USB (Universal Serial Bus) link and the like.

The exemplary PACS 31 comprises a plurality of Internet personal computers (PC) 310, a plurality of modalities 311, a web server 312, a workflow manager server 313, a PACS broker 314, a database server 315, an archive server 316, a backup archive server 317, a diagnostic workstation 318, a short term storage device 319A and a plurality of long term storage devices 319B. Please note that the members in PACS 31 may be optional, and more types of members, such as clinic workstation(s) may be included in a PACS of other embodiments. The Internet PC 310, modalities 311, archive server 316, backup archive server 317 and diagnostic workstation 318 may be connected to each of the web server 312, workflow manager server 313, PACS broker 314 and database server 315. The archive sever 316 may be connected with a short term storage device 319A and a long term storage device 319B, and the backup archive server 317 may be connected with a long term storage device 319B. The Internet PC 310, which may be replaced by a tablet or laptop, may be connected with Internet. The modalities 311 may comprise photographic machines, comprising but not limited to a X-Ray angiography system, a radio fluoroscopy system, a radiotherapy image system, a laparoscopy system, a computed tomography system, etc. for generating at least one image frame, here, a plurality of image frames, showing the biodegradable medical device 1 in a part of a human body. Preferably, the image frames may be taken during the medical surgery or the follow-up observation. For example, the image frames may be but not limited to taken during the medical surgery and then processed right away according to the embodiment of the present invention or later in an outpatient service, consultation, hospitalized inspection, etc. The web server 312 may be utilized for providing web services, such as viewing an image frame through IE browser. The workflow manager service 313 may manage priorities of work items. The PACS broker 314 may provide interfaces between the RIS 32 and the PACS 31 and the HIS 33 and the PACS 31. The database server 315 may provide function(s) associated with managing data, such as image frames. For example, the database server 315 may confirm the integrity of the data, maintain structure of a database, search in the database, etc. The archive server 316 or backup archive server 317 may receive image frame(s) sent from the modalities 311 and control the operation of other members in the PACS 31 to store or transmit the image frame(s) to one of the member.

The exemplary RIS 32 may comprise a RIS counter 321 and a RIS report system 322, both of which connect with the PACS 31. The RIS counter 321 and RIS report system 322 as well may access patient care information or administration information from the HIS 33 and transmit to or receive image frame(s) from the PACS 31 for diagnosis or preparing medical report(s). The RIS counter 321 and RIS report system 322 may be implemented by but not limited to a computer, a tablet or a laptop, which may comprise a display device, a human-computer interaction device and a processor.

The exemplary HIS 33 may comprise a report server 331, a patient ID/admission, discharge, and transfer (PID/ADT) system 332 and a computerized physician order entry (CPOE) system 333. The HIS 33 may collect, store, process, retrieve patient care information and administration information and communicate with the PACS 31 and RIS 32. The PID/ADT system 332 and CPOE system 333 may be implemented by but not limited to a computer, a tablet or a laptop, which may comprise a display device, a human-computer interaction device and a processor.

The processor executing the method of the embodiment of the present invention may be installed in a member of either the PACS 31, RIS 32 or HIS 33, such as but not limited to in a PC 310, a modality 311 or a diagnostic workstation 318 of the PACS 31, in a RIS counter 321 or a RIS report device 322 of the RIS 32, or in a PID/ADT 332 or an CPOE system 333 of the HIS 33. Here in the present exemplary embodiment, the processor may be installed in a X-ray angiography system, which may comprise a display device, a human-computer interaction device and a processor, as one of the modalities 311 in the PACS 31, which complies with digital imaging and communications in medicine (DICOM) standard, for facilitating cardiac angiography performed in a surgery. In another embodiment, the processor may be installed in a CPOE system 333 for image processing in a follow-up observation.

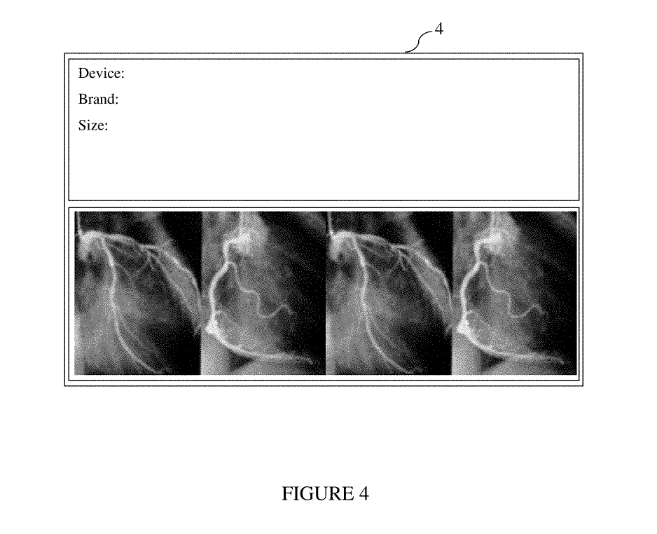

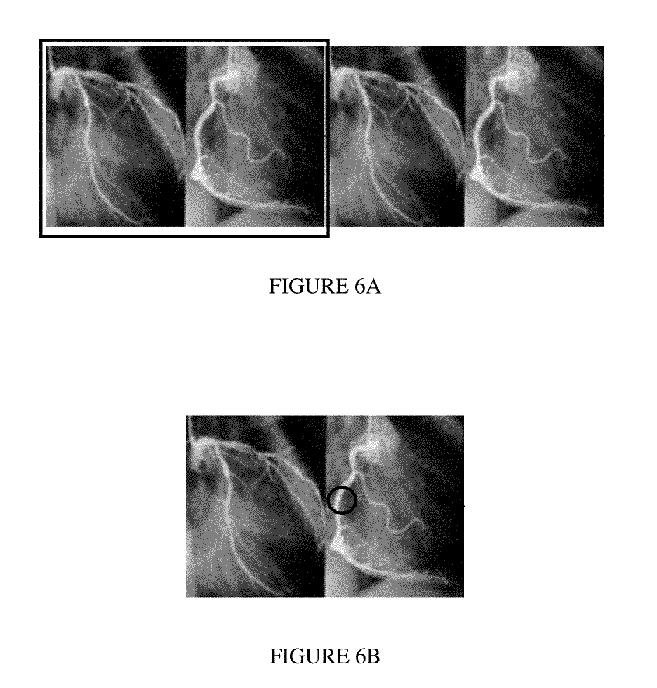

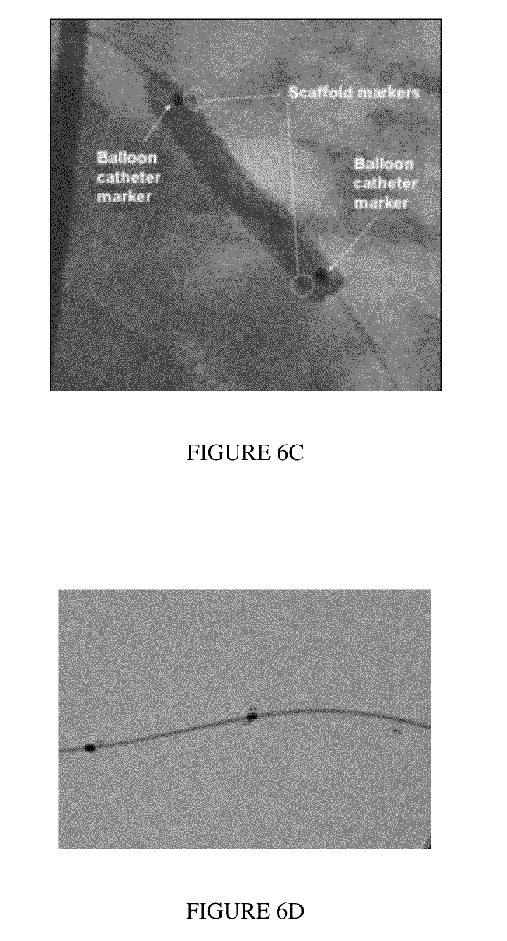

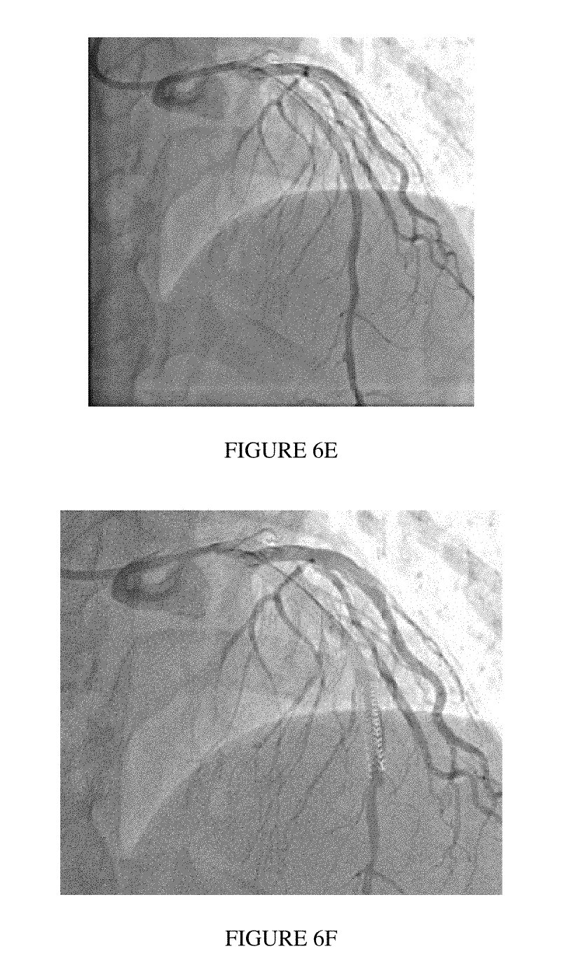

The display device may display an interactive interface (shown in FIG. 4 for example), operated by the processor. The human-computer interaction device may receive a confirmation or direction from a user. The processor may be configured to execute a method for processing at least one image frame showing a biodegradable medical device in a part of a human body as illustrated in FIG. 6. The member(s) having the processor, such as the modality 311 may be separately positioned in different rooms or regions in a hospital, clinic, medical station, etc. to facilitate access. In the present embodiment, the display device may be chosen from but not limited to a projector, monitor, display panel, etc., and the human-computer interaction device of may be chosen from but not limited to a mouse, keyboard, touch sensor integrated with the display panel, a stylus to touch the touch sensor, etc. Please note the method according to the embodiment of the present invention is not limited to the system structure shown in FIG. 3.

The PACS 31 may generate image frame(s) in digital format through one of the technologies comprising computed radiography, digital radiography, etc. with an image carrier, such as one of an image plate, cesium iodine (CsI)/charge-coupled device (CCD) flat panel, CsI/amorphous silicon (A-Si) flat panel, amorphous selenium (A-Se) fluid with pixel panel constructed by capacitors and thin-film transistor, etc., as an intermediate between images of X-ray form, light form and/or electrical signal form. The generated image frames may be homologous with variation in X-ray absorption distributed on the image carrier, and then stored in the short term storage device 319A or one of the long term storage devices 319B. At least one image frame may be transmitted to a member(s) having the processor which sends a request of the specific image frame image(s) to the PACS 31 on the communication links.

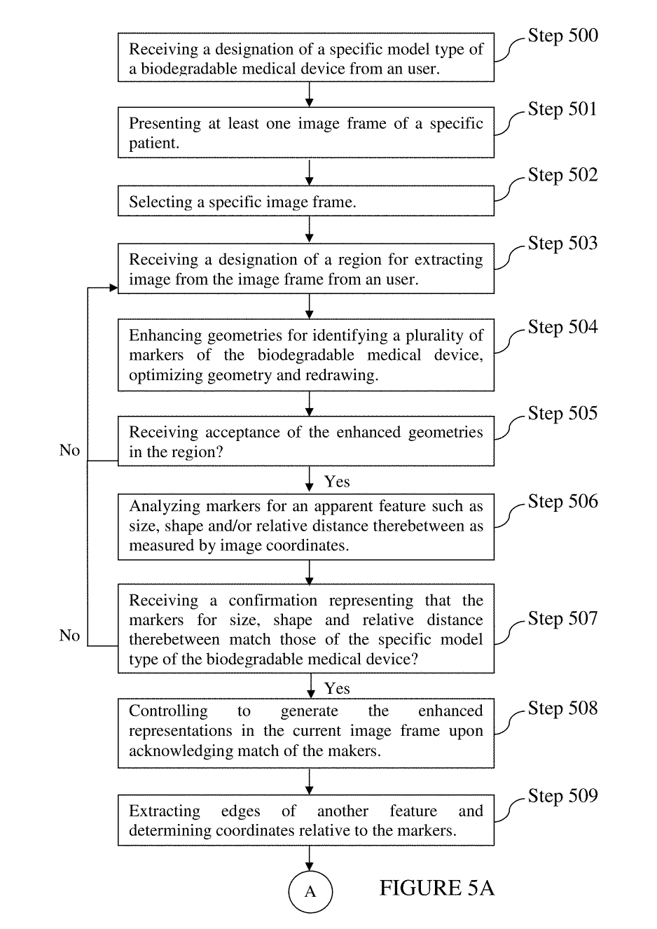

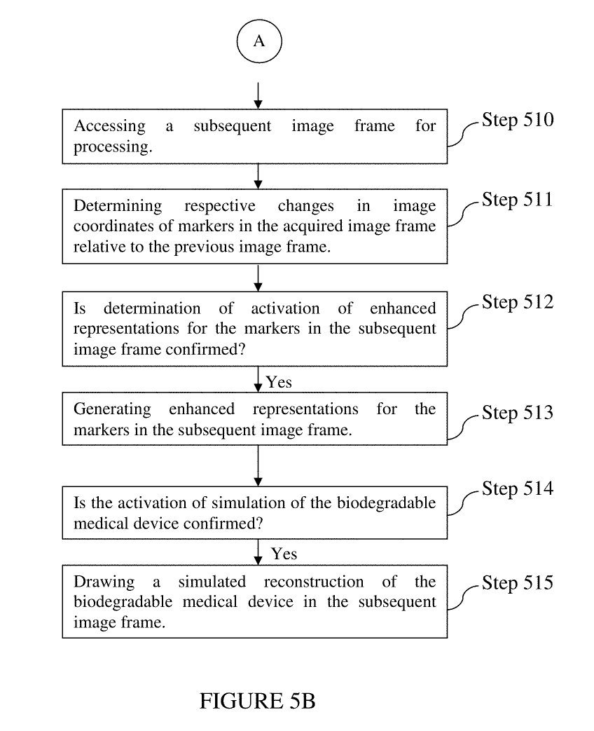

Please refer to FIG. 4, FIG. 5A, FIG. 5B as well as FIGS. 6A-6F. FIG. 4 shows an example embodiment of an interactive interface 4 according to an embodiment of the invention; FIG. 5A and FIG. 5B illustrate an example embodiment of a flow chart of a method for processing the image frame showing a biodegradable medical device in a part of a human body according to an embodiment of the invention; and FIGS. 6A-6F show an drawn example embodiment of the processed image frame shown in the interactive interface in the steps of the method as illustrated in FIG. 5A and FIG. 5B. Please note that here the system 3 shown in FIG. 3 is taken as an example of the system performing the method for processing the image frame showing a biodegradable medical device in a part of a human body according to the embodiment of the invention, but the method is not limited to be executed in the system 3. The interactive interface 4 may be shown on/by the display device. The interactive interface 4 may comprise at least two fields, one of the fields may show information related to the model type of the biodegradable medical device, such as device name, brand, size, etc., and the other field may show the image frame(s). The arrangement of these fields may be varied, for example, in two fields adjacent side by side, i.e. a right field and a left field, or in other form with more field(s) added for showing/entering more information or providing more function(s). The interactive interface 4 may be utilized for receiving confirmations or directions, which are discussed later.

At first, the interactive interface shown in a member having the processor, such as a modality 311 may be utilized for receiving a designation of a specific model type of a biodegradable medical device from a user (Step 500), presenting at least one image frame of a specific patient (Step 501), and selecting a specific image frame (Step 502). Please note that the order of Step 500 may be changed to behind Step 501 or Step 502. In Step 501, the image frame may be acquired from another member if the member having the processor does not keep the image frame. The input information, related to the model type of the biodegradable medical device, may be utilized and sufficient for knowing all the details about the specific type of the biodegradable medical device; however, for simplifying the operation, it may be more desirable that the modality 311 having the processor accesses a catalogue of various kinds of biodegradable medical device in which their corresponding features in appearance, including number, position, shape, etc. of targets, are listed. The catalogue may be stored in a member of PACS 31, RIS 32 or HIS 33, such as in the modality 311 having the processor, long term storage 319B or diagnostic workstation 318. Here a coronary stent with a pair of metal beads in one end is taken as an example of the biodegradable medical device with markers in a vicinity of an end of the biodegradable medical device. The image frame stored in the database server 33 is then transmitted to the modality 311 having the processor by diagnostic workstation 318, for example. As shown in FIG. 6A, image frames showing a part of a human heart taken in a medical procedure are displayed. When the interactive interface 4 acknowledges the selection, which may be represented by dot(s), square, motion(s) defined by human operations, the processor controls the display device to show the designated image frame only. Here, in the present embodiment, the right image frame is designated by a square.

Then, the interactive interface 4 may be utilized for receiving a designation of a region for extracting image from the image frame from a user, as shown in FIG. 6B, when a region delimited by a close shape, for example, a square, round, etc., is acknowledged, only the image inside the region may be shown, and preferably the image of the region may be enlarged (Step 503). The region may be represented to an approximate location of the markers. Then, geometries in a vicinity of a position, specified through the interactive interface, or in the region of the image frame are enhanced for identifying a plurality of markers of the biodegradable medical device (Step 504). Densitometry and grayscale differentiation within user-delimited region of image may be applied for identification. The identification of the markers may be performed based on information in the specifications of the model type of the biodegradable medical device (for instance, the information of the shape of the markers provided in the specifications of the biodegradable medical device may be used to distinguish the markers from other object showing in the image frame, so as to facilitate identifying the markers). Geometries of the identified shapes are enhanced for an optimizing result and then the markers are redrawn with the enhanced geometry. As shown in FIG. 6C, the markers on the coronary stent as well as the marker bands on the guidewire may be identified. Therefore, through Step 504, preferably, the location of the biodegradable medical device may be accurately estimated. The interactive interface 4 may be utilized for receiving acceptance of the enhanced geometries in the region from the user (Step 505).

Then, as shown in FIG. 6D, the markers may be analyzed for estimating an apparent feature such as size, shape, relative distance therebetween as measured by image coordinates for matching those of the specific model type of the biodegradable medical device (Step 506). The estimated apparent feature may be presented in a various types of format, such as graphics, words, digits, lines, shapes, etc. on the interactive interface, for example, a specific model type number of the biodegradable medical device matching the apparent feature on the interactive interface may be shown on the interactive interface. The apparent feature may be optionally matched in a list of biodegradable medical device specifications (which can be a data structure in which specifications of at least one model type of the biodegradable medical device are listed). The interactive interface 4 may be utilized for receiving a confirmation representing that the markers for size, shape and/or relative distance therebetween match those of the specific model type of the biodegradable medical device (Step 507). Therefore, through Step 507, preferably, the model type of the biodegradable medical device inside the human body may be verified.

The interactive interface 4 may be used for receiving an activation of generating enhanced representations for the markers in the current or subsequent image frame. In the present embodiment, it is assumed that this is activated both for the present image frame and subsequent image frame. Then, after Step 507, upon the processor acknowledging match of the makers, it controls to generate the enhanced representations in the current image frame (Step 508). Please see FIG. 6E for the shown current image frame. Edges of another feature other than the markers, such as distribution of vessel(s), external structure of a medical device which is already placed inside the human body, in the current image frame may be extracted and coordinates relative to the markers may be determined respectively to improve accuracy of subsequent confirmations (Step 509). In addition, it is optional to draw a simulated reconstruction of the biodegradable medical device based on the identified markers and specifications of the model type of the biodegradable medical device available in the specifications of the model type of the biodegradable medical device (for example, the simulated reconstruction of the biodegradable medical device can be drawn based on information of relative position of the markers and the biodegradable medical device, which can be provided in the specifications of the model type of the biodegradable medical device).

Afterwards, a subsequent image frame is accessed for processing (Step 510), respective changes in image coordinates of markers in the acquired image frame are determined relative to the previous image frame (Step 511), determination of activation of enhanced representations for the markers in the subsequent image frame is then confirmed (Step 512), and then enhanced representations for the markers are generated in the subsequent image frame (Step 513).

Further, the interactive interface 4 may be used for receiving an activation of drawing a simulated reconstruction of the biodegradable medical device in the subsequent image frame. When the activation is confirmed (Step 514), a simulated reconstruction of the biodegradable medical device is drawn in the subsequent image frame (Step 515), and the whole image frame is shown in FIG. 6F. The simulated reconstruction may be adjacent to and/or between the markers based on geometry of the biodegradable medical device. The simulated reconstruction of the biodegradable medical device may be generated based on the identified markers and specifications of the model type of the biodegradable medical device available in the specifications of the model type of the biodegradable medical device. Therefore, through Steps 510-515, preferably, each image frame after the first one may be shown with a simulated reconstruction of the biodegradable medical device for facilitating observation without repeating Steps 501-509. In another embodiment, the method may merely comprise above Steps 501 and 504, and the rest steps are optional to be added if required.

It is to be understood that these embodiments are not meant as limitations of the invention but merely exemplary descriptions of the invention with regard to certain specific embodiments. Indeed, different adaptations may be apparent to those skilled in the art without departing from the scope of the annexed claims.

What is claimed is:

1. A computer-implemented method for processing an image frame showing a biodegradable medical device in a part of a human body, comprising executing on a processor the steps of:
presenting, with the processor, an interactive interface for human-computer interaction;
receiving a designation of a specific model type of the biodegradable medical device from a user via the interactive interface; and
identifying, with the processor, a plurality of markers of the biodegradable medical device based on specifications of the model type of the biodegradable medical device.

2. The computer-implemented method according to claim 1, further comprising:
generating an enhanced representation of the markers in the interactive interface; and
drawing a simulated reconstruction of the biodegradable medical device in the interactive interface.

3. The computer-implemented method according to claim 1, further comprising:
estimating, with the processor, an apparent feature comprising at least one of size, shape of the markers and relative distance between the markers; and
presenting the estimated apparent feature on the interactive interface.

4. The computer-implemented method according to claim 1, further comprising:
estimating, with the processor, an apparent feature comprising at least one of size, shape of the markers and relative distance between the markers;
matching, with the processor, the apparent feature in a data structure in which specifications of at least one model type of the biodegradable medical device are listed;
presenting, with the processor, a specific model type number of the biodegradable medical device matching the apparent feature on the interactive interface; and
providing, with the processor, the interactive interface for receiving a confirmation representing that the markers match the specific model type of the biodegradable medical device from the user.

5. The computer-implemented method according to claim 1, further comprising:
extracting, with the processor, edges of a graphical feature, which is beyond the markers, in the image frame; and
determining, with the processor, coordinates of the graphical feature relative to the markers.

6. The computer-implemented method according to claim 1, further comprising:
determining, with the processor, respective change in coordinates of the markers in a subsequent image frame.

7. A computer-implemented method for processing an image frame showing a biodegradable medical device in a part of a human body, comprising executing on a processor the steps of:
presenting, with the processor, an interactive interface for presenting an image frame showing a part of a human body and receiving a designation of a position in the image frame from a user;
identifying, with the processor, a plurality of markers of the biodegradable medical device in a vicinity of the position in the image frame;
enhancing, with the processor, geometry of the shape of the markers; and
redrawing, with the processor, the markers with the enhanced geometry.

8. The computer-implemented method according to claim 7, further comprising:
providing, with the processor, the interactive interface for receiving a selection of the image frame to be presented from the user, and receiving an acceptance of the identification of the markers from the user.

9. The computer-implemented method according to claim 7, further comprising:
extracting, with the processor, edges of a graphical feature, which is beyond the markers, in the image frame; and
determining, with the processor, coordinates of the graphical feature relative to the markers.

10. The computer-implemented method according to claim 7, further comprising:
determining, with the processor, respective change in coordinates of the markers in a subsequent image frame.

11. The computer-implemented method according to claim 10, further comprising:
providing, with the processor, the interactive interface for receiving an activation of generating, with the processor, enhanced representations for the markers in the subsequent image frame; and
generating, with the processor, the enhanced representations for the markers in the subsequent image frame according to the determined respective change in coordinates of the markers.

12. The computer-implemented method according to claim 10, further comprising:
providing, with the processor, the interactive interface for receiving an activation of drawing a simulated reconstruction of the biodegradable medical device in the subsequent image frame; and
drawing, with the processor, the simulated reconstruction of the biodegradable medical device adjacent to or between the markers in the subsequent image frame according to the determined respective change in coordinates of the markers.

13. The computer-implemented method according to claim 7, wherein the step of identifying, with the processor, a plurality of markers of the biodegradable medical device in a vicinity of the position in the image frame comprises:
detecting, with the processor, a shape of the markers in the vicinity of the position with densitometry or grayscale differentiation.

14. A computer-implemented method for processing an image frame showing a biodegradable medical device in a part of a human body, comprising executing on a processor the steps of:
presenting, with the processor, an interactive interface for human-computer interaction;
identifying, with the processor, a plurality of markers of the biodegradable medical device; and
analyzing, with the processor, geometry of the markers for matching a model type of the biodegradable medical device.

15. The computer-implemented method according to claim 14, wherein the step of analyzing, with the processor, the geometry of the markers for matching the model type of the biodegradable medical device comprises:
estimating, with the processor, an apparent feature comprising at least one of size, shape of the markers and relative distance between the markers; and
matching the apparent feature in a list of biodegradable medical device specifications.

16. The computer-implemented method according to claim 14, further comprising:
generating an enhanced representation of the markers in the interactive interface; and. drawing a simulated reconstruction of the biodegradable medical device in the interactive interface.

17. A computer-implemented method for processing an image frame showing a biodegradable medical device in a part of a human body, comprising executing on a processor the steps of:
presenting, with the processor, an interactive interface for human-computer interaction;
receiving a designation of a specific model type of the biodegradable medical device from a user via the interactive interface;
identifying, with the processor, a plurality of markers of the biodegradable medical device; and
drawing a simulated reconstruction of the biodegradable medical device in the interactive interface based on the identified markers and specifications of the model type of the biodegradable medical device.

18. The computer-implemented method according to claim 17, wherein the step of drawing a simulated reconstruction of the biodegradable medical device in the interactive interface based on the identified markers and specifications of the model type of the biodegradable medical device comprises:
drawing the simulated reconstruction of the biodegradable medical device based on information of relative position of the markers and the biodegradable medical device in the specifications of the model type of the biodegradable medical device.

19. A system for processing an image frame showing a biodegradable medical device in a part of a human body, comprising:
at least one display device, displaying the image frame;
a human-computer interaction device, configured to facilitate human-computer interaction; and
a processor, configured to receive a designation of a specific model type of the biodegradable medical device from a user via the human-computer interaction device, and identify a plurality of markers of the biodegradable medical device based on specifications of the model type of the biodegradable medical device.

20. The system according to claim 19, wherein the processor is mounted in an angiography machine.

21. The system according to claim 19, wherein the biodegradable medical device is a coronary stent.

22. The system according to claim 19, wherein the markers are mounted on the biodegradable medical device, embedded in the biodegradable medical device, or attached to the biodegradable medical device.

23. The system according to claim 19, wherein the markers are placed in a vicinity of an end of the biodegradable medical device.

24. A system for processing an image frame showing a biodegradable medical device in a part of a human body, comprising:
at least one display device, displaying the image frame;
a human-computer interaction device, receiving a confirmation or direction from a user; and
a processor, configured to present an interactive interface for presenting an image frame showing a part of a human body and receiving a designation of a position in the image frame from a user, identify a plurality of markers of the biodegradable medical device in a vicinity of the position in the image frame, enhance geometry of the shape of the markers, and redraw the markers.

25. A system for processing an image frame showing a biodegradable medical device in a part of a human body, comprising:
at least one display device, displaying the image frame;
a human-computer interaction device, configured to facilitate human-computer interaction; and
a processor, configured to identify a plurality of markers of the biodegradable medical device, and analyze geometry of the markers for matching a model type of the biodegradable medical device.

26. A system for processing an image frame showing a biodegradable medical device in a part of a human body, comprising:
at least one display device, displaying the image frame;
a human-computer interaction device, configured to facilitate human-computer interaction; and
a processor, configured to receive a designation of a specific model type of the biodegradable medical device from a user via the human-computer interaction device, identify a plurality of markers of the biodegradable medical device, and draw a simulated reconstruction of the biodegradable medical device on the display device based on the identified markers and specifications of the model type of the biodegradable medical device.
